(19) United States
(12) Patent Application Publication
(10) Pub. No.: US 2008/0054320 A1
(43) Pub. Date: Mar. 6, 2008

(54) Method, apparatus and system providing suppression of noise in a digital imager

(75) Inventors: Johannes Solhusvik, Arcadia, CA (US); Kwang-Bo Cho, Los Angeles, CA (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/513,392

(22) Filed: Aug. 31, 2006

(51) Int. Cl. H01L 31/113

(52) U.S. Cl. 257/292

(57) ABSTRACT

Method, apparatus and systems are disclosed in which a digital imager has optically black reference pixels in at least one row of a pixel array. The signals from the reference pixels in one row of the array are used as reference signals to cancel out the row-wise noise from pixel signals readout from active pixels in other rows of the array. An arrangement for locating the array driving circuit relative to the reference pixels is also provided.

### FIELD OF THE INVENTION

Embodiments of the invention relate generally to imager devices and more particularly to row-wise noise suppression for an imager device.

### BACKGROUND

A CMOS imager circuit includes a focal plane array of pixel cells, each one of the cells including a photosensor, for example, a photogate, photoconductor or a photodiode overlying a substrate for accumulating photo-generated charge in the underlying portion of the substrate. Each pixel cell has a readout circuit that includes at least an output field effect transistor formed in the substrate and a charge storage region formed on the substrate connected to the gate of an output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel cell perform the necessary functions of: (1) photon to charge conversion; (2) accumulation of image charge; (3) resetting the storage region to a known state; (4) transfer of charge to the storage region accompanied by charge amplification; (5) selection of a pixel for readout; and (6) output and amplification of a signal representing pixel charge. Photo charge may be amplified when it moves from the initial charge accumulation region to the storage region. The charge at the storage region is typically converted to a pixel output voltage by a source follower output transistor.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc., which are hereby incorporated by reference in their entirety.

FIG. 1 illustrates a portion of a conventional CMOS imager 10. The illustrated imager 10 includes a pixel 20, one of many that are in a pixel array (not shown), connected to a column sample and hold circuit 40 by a pixel output line 32. The imager 10 also includes a readout programmable gain amplifier (PGA) 70 and an analog-to-digital converter (ADC) 80.

The illustrated pixel 20 includes a photosensor 22 (e.g., a pinned photodiode, photogate, etc.), transfer transistor 24, floating diffusion region FD, reset transistor 26, source follower transistor 28 and row select transistor 30. FIG. 1 also illustrates parasitic capacitance Cp1 associated with the floating diffusion region FD and the pixel's 20 substrate. The photosensor 22 is connected to the floating diffusion region FD by the transfer transistor 24 when the transfer transistor 24 is activated by a transfer control signal TX. The reset transistor 26 is connected between the floating diffusion region FD and an array pixel supply voltage Vaa-pix. A reset control signal RST is used to activate the reset transistor 26, which resets the floating diffusion region FD (as is known in the art).

The source follower transistor 28 has its gate connected to the floating diffusion region FD and is connected between the array pixel supply voltage Vaa-pix and the row select transistor 30. The source follower transistor 28 converts the stored charge at the floating diffusion region FD into an electrical output voltage signal. The row select transistor 30 is controllable by a row select signal SELECT for selectively connecting the source follower transistor 28 and its output voltage signal to the pixel output line 32.

The column sample and hold circuit 40 includes a bias transistor 56, controlled by a control voltage Vln_bias, that is used to bias the pixel output line 32. The pixel output line 32 is also connected to a first capacitor 44 thru a sample and hold reset signal switch 42. The sample and hold reset signal switch 42 is controlled by the sample and hold reset control signal SAMPLE_RESET. The pixel output line 32 is also connected to a second capacitor 54 thru a sample and hold pixel signal switch 52. The sample and hold pixel signal switch 52 is controlled by the sample and hold pixel control signal SAMPLE_SIGNAL. The switches 42, 52 are typically MOSFET transistors.

A second terminal of the first capacitor 44 is connected to the amplifier 70 via a first column select switch 50, which is controlled by a column select signal COLUMN_SELECT. The second terminal of the first capacitor 44 is also connected to a clamping voltage VCL via a first clamping switch 46. Similarly, the second terminal of the second capacitor 54 is connected to the amplifier 70 by a second column select switch 60, which is controlled by the column select signal COLUMN_SELECT. The second terminal of the second capacitor 54 is also connected to the clamping voltage VCL by a second clamping switch 48.

The clamping switches 46, 48 are controlled by a clamping control signal CLAMP. As is known in the art, the clamping voltage VCL is used to place a charge on the two capacitors 44, 54 when it is desired to store the reset and pixel signals, respectively (when the appropriate sample and hold control signals SAMPLE_RESET, SAMPLE_SIGNAL are also generated).

Referring to FIGS. 1 and 2, in operation, the row select signal SELECT is driven high, which activates the row select transistor 30. When activated, the row select transistor 30 connects the source follower transistor 28 to the pixel output line 32. The clamping control signal CLAMP is then driven high to activate the clamping switches 46, 48, allowing the clamping voltage VCL to be applied to the second terminal of the sample and hold capacitors 44, 54. The reset signal RST is then pulsed to activate the reset transistor 26, which resets the floating diffusion region FD. The signal on the floating diffusion region FD is then sampled when the sample and hold reset control signal SAMPLE_RESET is pulsed. At this point, the first capacitor 44 stores the pixel reset signal Vᵣₛₜ.

Afterwards, the transfer transistor control signal TX is pulsed, causing charge from the photosensor 22 to be transferred to the floating diffusion region FD. The signal on the floating diffusion region FD is sampled when the sample and hold pixel control signal SAMPLE_SIGNAL is pulsed. At this point, the second capacitor 54 stores a pixel image signal V_{sig}. A differential signal (Vᵣₛₜ−V_{sig}) is produced by the differential amplifier 70. The differential signal is digitized by the analog-to-digital converter 80. The analog-to-digital converter 80 supplies the digitized pixel signals to an image processor (not shown), which forms a digital image output.

As can be seen from FIG. 1, most of the pixel readout circuitry is designed to be fully differential to suppress noise (substrate or power supply noise), which could create undesirable image artifacts (e.g., flickering pixels, grainy still images). The readout circuitry for the illustrated four transistor (“4T”) pixel, and known three transistor (“3T”) pixels, however, is single ended. During the sampling of the reset or pixel signal levels (described above), any noise on the substrate ground or clamp voltage is inadvertently stored on the sampling capacitors 44, 54. FIG. 3 illustrates portions of the imager 10 that are subject to substrate noise (e.g., at the floating diffusion region FD in the pixel 20 (arrow A) and the bias transistor 56 in the sample and hold circuitry 40 (arrow B)) and noise on the clamp voltage VCL (e.g., at clamping switches 46, 48 (arrow C)).

Because the sampling of the reset and pixel signal levels occur at different times, the random noise will be different between the two samples. Some components of the noise, however, are common to all the pixels sampled at the same time (e.g., noise caused by the power supply, the bias voltage, or ground bounce, or substrate noise that is picked up by the floating diffusion region FD and the clamp voltage noise). When the pixels are sampled, the noise appears as horizontal lines in the image that are superimposed on top of the actual image. This common noise is referred to as “row-wise noise” because the noise for all pixels sampled is correlated.

There is a desire and need to mitigate the presence of row-wise noise in acquired images.

### BRIEF DESCRIPTION OF THE DRAWINGS

FIG. 1 is a diagram of a portion of a typical CMOS imager.

FIG. 2 is a timing diagram of the operation of the FIG. 1 imager.

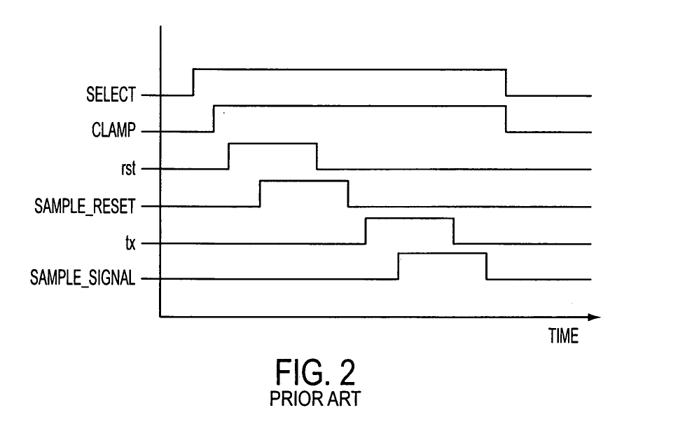

FIG. 3 is a diagram illustrating noise sources in the FIG. 1 imager.

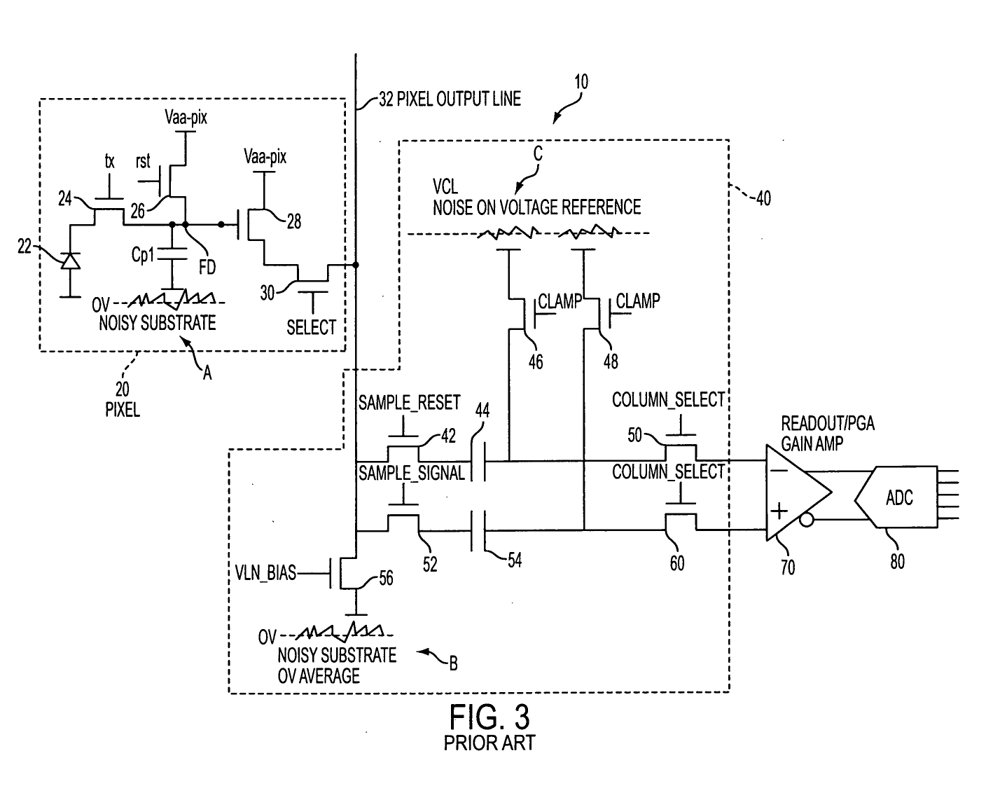

FIG. 4 is a diagram of a portion of a CMOS imager constructed in accordance with an embodiment of the invention.

FIG. 5 illustrates a readout path for the FIG. 4 imager.

FIG. 6 illustrates pixel signal processing according to an embodiment of the invention.

FIG. 7 is a diagram of a portion of a CMOS imager constructed in accordance with an embodiment of the invention.

FIG. 8 is a diagram of a portion of a CMOS imager constructed in accordance with an embodiment of the invention.

FIG. 9 is a diagram of a portion of a CMOS imager constructed in accordance with an embodiment of the invention.

FIG. 10 shows a processor system incorporating at least one imager device constructed in accordance with an embodiment of the invention.

### DETAILED DESCRIPTION

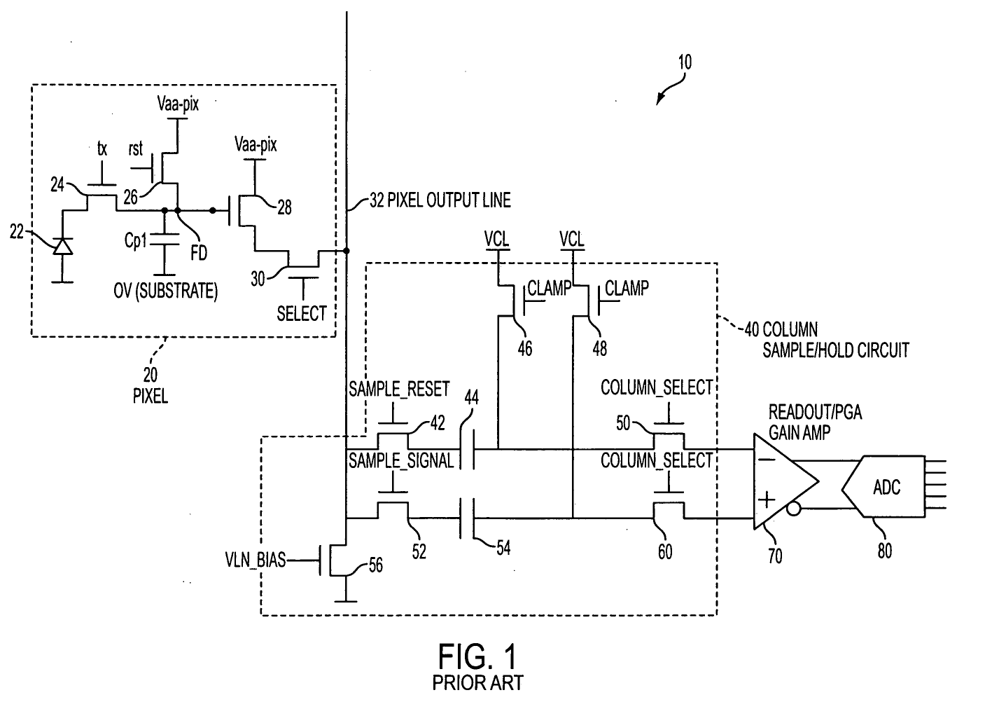

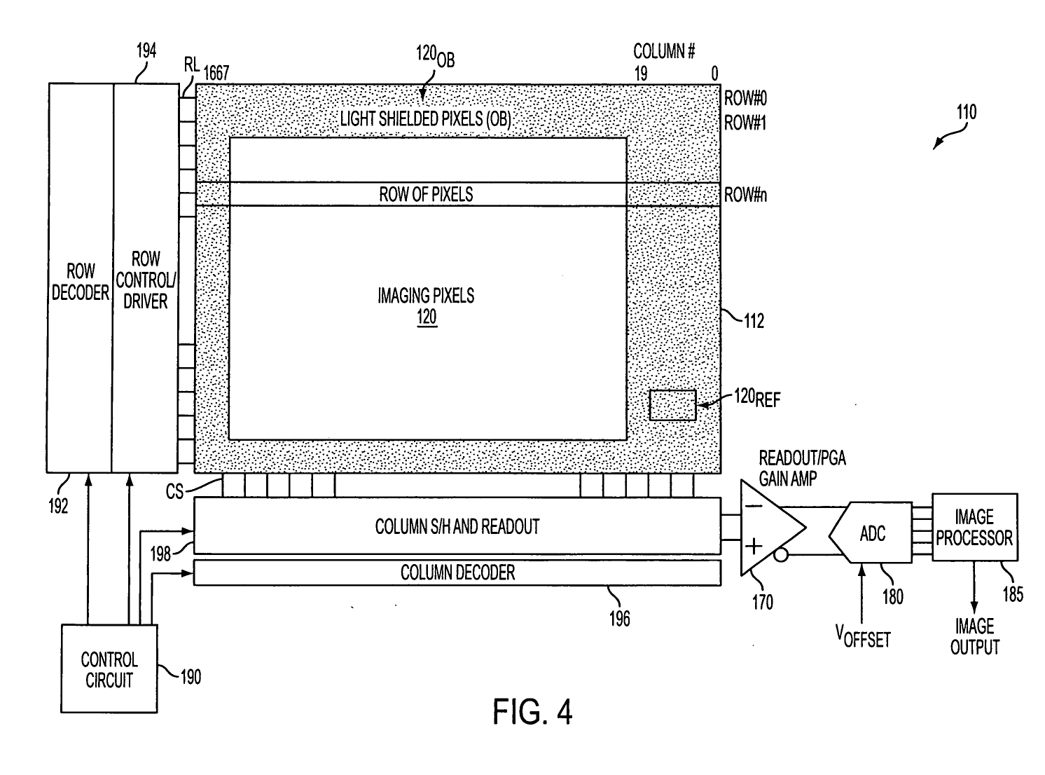

Referring to the figures, where like reference numbers designate like elements, FIG. 4 shows of a portion of a CMOS imager 110 constructed in accordance with an embodiment of the invention. The imager 110 includes a pixel array 112 comprised of active imaging pixels 120. The array 112 contains light shielded optically black (“OB”) pixels 120_{OB}. In addition, the array 112 contains reference pixels 120_{REF}, which are light shielded optically black pixels, associated with one or more rows of the array, including rows having no active pixels. The OB and reference pixels, 120_{OB} and 120_{REF}, are discussed below in more detail. The pixels 120, 120_{OB}, 120_{REF} may each have the construction of the 4T pixel illustrated in FIG. 1, or other types of pixel architectures suitable for use in a CMOS imager (e.g., 3T, 5T, etc.). That is, embodiments of the invention are not limited to any particular pixel circuit configuration.

The illustrated imager 110 also contains a control circuit 190, row decoder 192, row controller/driver 194, column S/H and readout circuitry 198, a column decoder 196, readout/PGA gain amplifier 170, analog-to-digital converter 180 and an image processor 185. Row lines RL connected to the pixels 120, 120_{OB}, 120_{REF} of the array 112 are selectively activated by the row driver 194 in response to the row address decoder 192. Column select lines CS are selectively activated by the column S/H and readout circuit 198 in response to the column address decoder 196. Pixel output lines for each column in the array are also connected to the column S/H and readout circuitry 198, but are not shown in FIG. 4.

The CMOS imager 110 is operated by the control circuit 190, which controls the decoders 192, 196 for selecting the appropriate row and column lines for pixel readout. The control circuit 190 also controls the row control/driver and column S/H and readout circuitry 194, 198, which apply driving voltages to the drive transistors of the selected row and column lines. The control circuit 190 also controls other signals (e.g., SAMPLE_RESET and SAMPLE_SIGNAL illustrated in FIG. 1) needed by the column S/H and readout circuitry 198 to readout, sample, hold and output reset and pixel signals.

Imager 110 also includes circuitry for concurrently selecting pixels in multiple rows. For example, circuitry implemented using any of components 190, 192, 194, 196, or 198 can cause active pixels 120 located in a first row of the array to receive a high row select signal at the same time reference pixels 120_{REF} located in a second row of the array receive a high row select signal. The specific circuitry driving reference pixels 120_{REF} could be adjusted for smaller capacitive loads compared to the circuitry driving active pixels 120. One way of implementing this functionality could be to connect a high DC signal to row select inputs of reference pixels 120_{REF} so that reference pixels 120_{REF} always receive a high row select signal.

Imager 110 also includes circuitry allowing reference pixels 120_{REF} to receive control signals different than control signals concurrently received by active pixels 120. For example, circuitry implemented using any of components 190, 192, 194, 196, or 193 could cause active pixels 120 to receive a high TX control signal at the same time reference pixels 120_{REF} receive a low TX control signal. Ensuring that the TX control signal stays low in reference pixels 120_{REF} while circuitry pulses high the TX control signal for active pixels avoids sensitivity to light and ensures true correlated double sampling in reference pixels 120_{REF}. One way of implementing this functionality could be to drive the transfer transistors in each reference pixel 120_{REF} with the reset control signal RST, which will be low when the TX control signal to the active pixels goes high.

The sample and hold portion of the column S/H and readout circuitry 198 reads a pixel reset signal Vᵣₛₜ and a pixel image signal V_{sig} for selected pixels. A differential signal (Vᵣₛₜ−V_{sig}) is produced by differential amplifier 170 for each pixel and is digitized by analog-to-digital converter 180. The analog-to-digital converter 180 supplies the digitized pixel signals to the image processor 185, which forms a digital image output.

The reference pixels 120_{REF} are light shielded. One technique for shielding the reference pixels 120_{REF} is to cover them with metal. Because the reference pixels 120_{REF} are light shielded, the only signal that should be read from them should is dark current. The reference pixels 120_{REF}, however, experience similar row-wise noise superimposed on their signals that is experienced by the active pixels 120 that are selected at the same time. Thus, the row-wise noise for the selected active pixels 120 can be estimated from the reference pixels 120_{REF}. This associated row-wise noise can therefore be removed from the signals output by the selected active pixels 120 (discussed below).

Typically, all circuits contain fundamental noise sources due to thermal noise, 1/f noise, and shot noise. The pixel's source follower transistor, the sample and hold circuitry (e.g., column S/H and readout circuitry 198), readout amplifier 170 and analog-to-digital converter 180 each contribute noise during the imager's 110 readout operation (the ADC 180 also adds quantization noise). In imager applications, this noise is referred to as “readout noise.” Readout noise limits the minimum detectable signal that is read from the pixels. Readout noise is random from pixel to pixel.

To avoid increasing the overall pixel readout noise, multiple light shielded, OB reference pixels 120_{REF} are readout and averaged in the illustrated embodiment. The averaging step reduces readout noise by a factor of the square root of the number of samples. For example, taking the average of sixteen reference pixels 120_{REF} reduces readout noise by a factor of four.

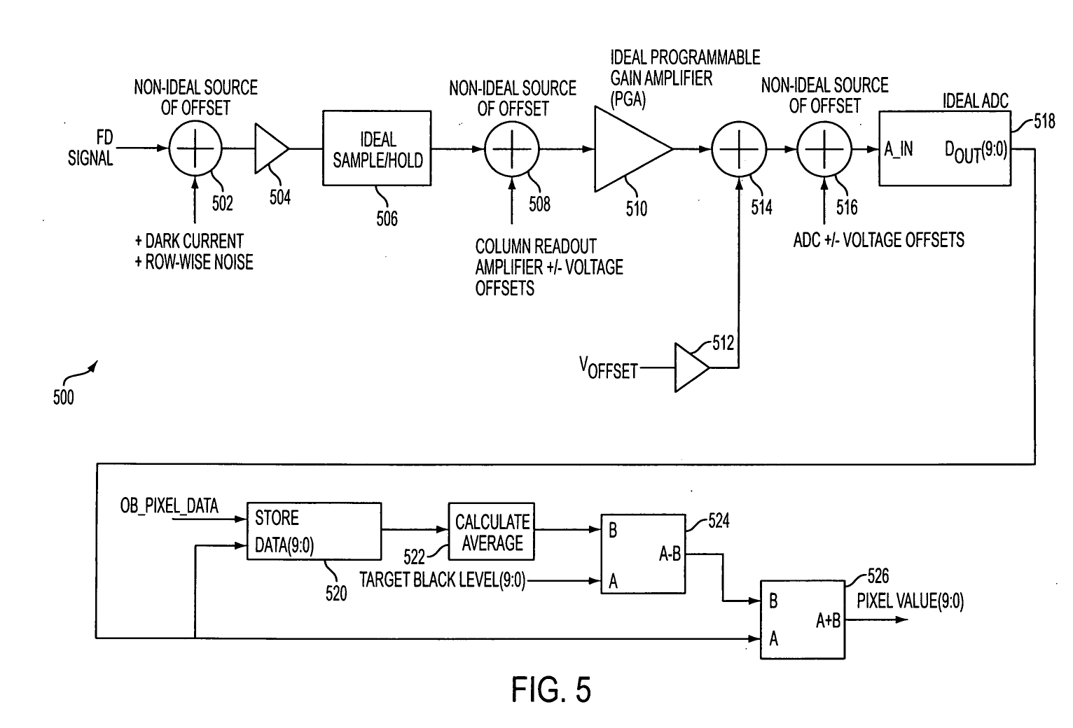

FIG. 5 illustrates conceptually and partially schematically a readout path 500 for the imager 110 illustrated in FIG. 4. The illustrated path 500 shows various offsets experienced during pixel readout. The majority of the processing performed within the readout path may be controlled by the image processor 185 (FIG. 4). It should be appreciated that the processing of embodiments of the invention may be performed in hardware, software or a combination of hardware and software and is not limited to the illustrated image processor.

The start of the path 500 is the inputting of a signal FD SIGNAL from the pixel's floating diffusion region. The FD SIGNAL could be a reset signal or a pixel signal that has been taken from the pixel's FD region. Dark current and row-wise noise offsets are unintentionally applied to the FD SIGNAL at summation block 502. Dark current is a source of offset that tends to vary from pixel to pixel, whereas the row-wise noise is the same for each pixel in the same row.

The FD SIGNAL (with offsets) is buffered in a buffer 504 (representative of the source follower transistor in the pixel) and output to a sample and hold circuit 506. Non-ideal circuit elements such as the programmable gain amplifier and analog-to-digital converter will require input offsets (for mismatch in transistor characteristics). Thus, column readout+/−voltage offsets may be added at the second summation block 508 before the signal enters the amplifier 510. In addition, ADC+/−voltage offsets may be added at the fourth summation block 516 before the signal enters the ADC 518.

As explained below, these offsets are superimposed on the digitized reset and pixel signals. Thus, even if there is very little light impinging on the pixel, the analog pixel signal may not be exactly zero. The analog signal could be more positive, or worse, it could be negative. Because the analog-to-digital converter outputs only positive values, a negative signal will be clipped to zero. To prevent clipping, a positive voltage offset Voffset is added to the path 500 at block 514. The offset voltage Voffset is also made positive enough to avoid clipping due to random noise in the path 500. The resulting analog positive level above the zero value is referred to herein as the “dark level pedestal.”

Referring to FIGS. 4 and 5, the dark level pedestal is generated by measuring the OB pixels 120_{OB} located at the top of the pixel array 112. An average of the signal levels of the OB pixels 120_{OB} is then used to set the analog pedestal level to a target range.

After the analog pixel signal is digitized by the ADC 518, it enters a digital portion of the path 500. As a row is readout, the signals being processed (now digital signals) from the reference pixels 120_{REF} are readout first. If the signal is from a reference pixel 120_{REF}, the digital value output from the ADC is stored in a set of registers 520. In the illustrated embodiment, there is a register capable of storing ten bits each for every reference pixel 120_{REF}. It should be appreciated that the invention is not limited to a specific number of reference pixels 120_{REF}. All that is required is that there be enough registers 520 to store the signal from each reference pixel 120_{REF}. A control signal OB_pixel_data is used to enter the digital data into the registers 520 when the data represents a signal from the reference pixels.

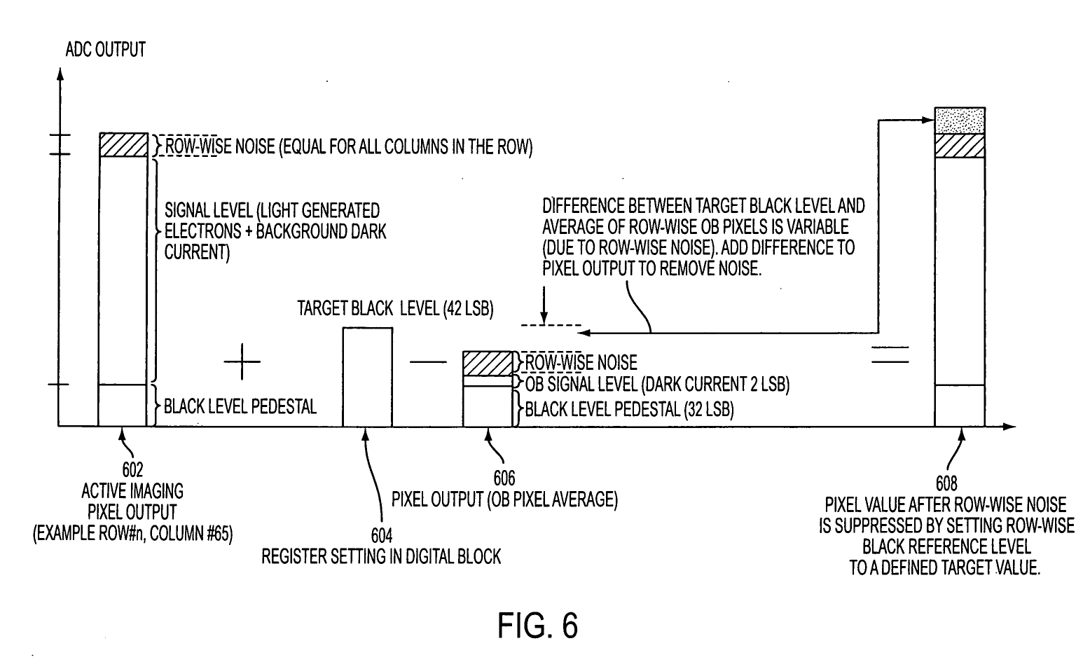

After all of the reference pixels 120_{REF} are readout, an average of their signals is taken at block 522. The average contains a value of row-wise noise to be used as described below. For example, for embodiments having sixteen reference pixels 120_{REF}, the random readout noise is reduced by a factor of four due to the averaging process. The reference pixels 120_{REF} also contain the built in dark level pedestal and any signal from the background dark current. To guarantee the same black level pedestal for the entire array, a frame-wise target black level is generated. The target black level is a predetermined selected value that ensures that each digital signal has a minimum black level regardless of noise. In an embodiment, the target black level is a minimum digital value of 42 (shown in FIG. 6 as 42 LSB). The target black level can be any digital level desired, can be preprogrammed or modifiable by a user if desired; as such, the invention is not to be limited to any particular target black level.

The difference between the calculated average and the target black level is determined in block 524 and input into adder block 526. Once all of the reference pixels 120_{REF} are readout, the active pixels 120 are readout. The active pixel path differs from the reference pixel path in that after exiting the ADC 518, a digitized active pixel signal goes directly to the adder block 526. The difference between the target black level and the average reference level (from block 524) is added to the digitized active pixel level for each pixel in the same row. This removes the row-wise noise from each reset and pixel signal in that row. It should be appreciated that most likely a different value is added at block 526 for each row of active pixels read.

FIG. 6 shows the components of the pixel level before and after row-wise noise correction. Arrow 602 points to an active pixel's output. The output 602 includes the black level pedestal, the signal level (i.e., from light generated electrons and background dark current) and a row-wise noise component. Arrow 604 points to the target black level (here having a digital value of 42). Arrow 606 points to the reference level, which has the black level pedestal (e.g., a digital value of about 32 shown as 32 LSB), an OB signal level (i.e., a dark current digital value of about 2 shown as 2 LSB) and the row-wise noise component, and the difference between the target black level and the average row-wise reference levels. Arrow 608 points to the resultant pixel value after row-wise noise is suppressed (due to the setting of the black reference level to a defined target level).

The row-wise noise correction of embodiments of the invention has a number of additional benefits. As noted above, the pedestal level is set to a desired range. An example of such a range is between the levels of a digital 29 and digital 35 (an exact level is typically not possible due to circuit noise). Row-wise noise correction then forces (i.e., clamps) the final black level to a particular digital value (e.g., 42 LSBs) as the “target black level.” Without the row-wise noise correction the black level would normally vary during the operation of the imager (creating a potential background beating problem). Also, in the case of multiple readout channels, offsets from each channel are equalized (which reduces potential mosaic artifacts from different offsets for red, blue and green readout channels).

The row-wise noise correction of embodiments of the invention removes variations in accumulated dark current in the pixel array as rows are readout. This feature is particularly useful when using an electronic shutter, where during operation, data on different rows are stored on the floating diffusion region for different times as the array is readout (the first readout row accumulates much less signal from background current than the last readout row).

It should be appreciated that the placement of the optically black reference pixels 120_{REF} (FIG. 4) could be on either or both sides of the pixel array in a horizontal direction. Thus, the calculated average level (described above with reference to FIG. 5) could be determined from pixels on both sides of the array. Additionally, one row could include all the reference pixels 120_{REF}, or the reference pixels 120_{REF} could be spread out over multiple rows if desired. In another embodiment of the invention, the averaging step can be designed to remove pixels that are defective or otherwise not within the expected distribution of the dark current signal level. Moreover, because different colored pixels in the array are readout with different gains, in another embodiment of the invention, the average is calculated on a per color basis. For example, if each row of an array had pixels dedicated to two colors, than an embodiment could have 36 reference pixels 102_{REF} for each color, or 72 total reference pixels 102_{REF}.

It should be appreciated that the reference pixels under the light shield should be placed away from the edge of the shield to prevent light leakage onto the OB and reference pixels.

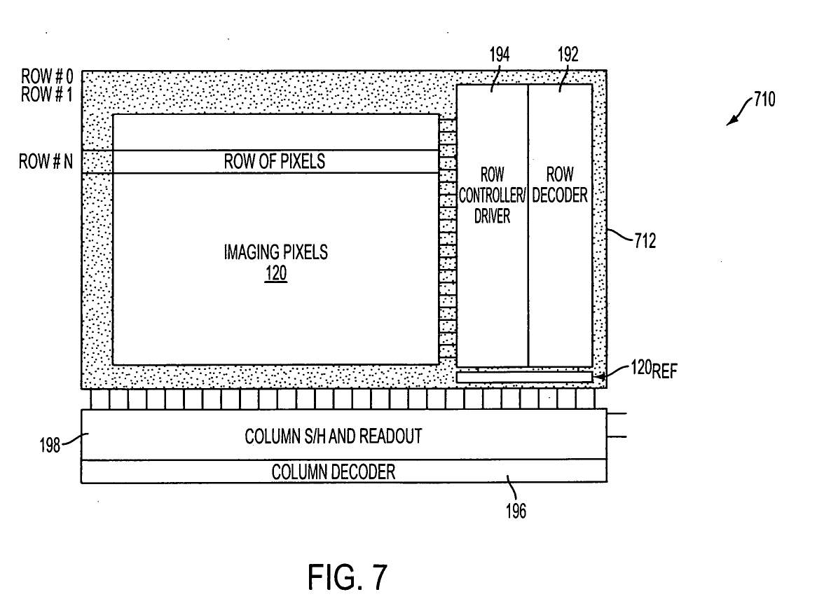

FIG. 7 shows of a portion of a CMOS imager 710 constructed in accordance with another embodiment of the invention. Imager 710 includes a pixel array 712 with active imaging pixels 120 and reference pixels 120_{REF} located in one row of array 712. Having reference pixels 120_{REF} in a limited number of rows creates space on the array for other components of imager 710, which could be implemented above, below, or to the sides of reference pixels 120_{REF}. For example, as shown in FIG. 7, row decoder 192 and row control/driver 194 could be implemented in the space located vertically above the row having reference pixels 120_{REF}. This configuration results in a smaller imager 710, which is very desirable.

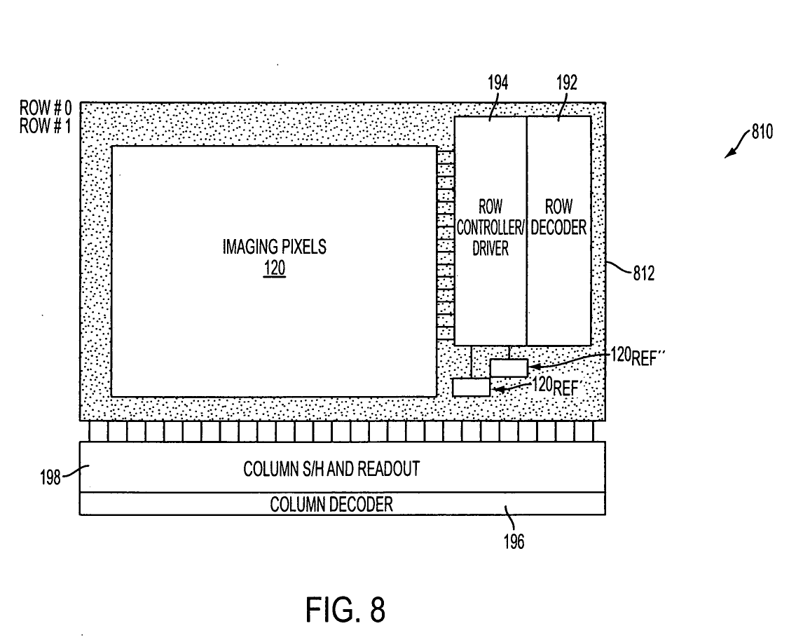

FIG. 8 shows of a portion of a CMOS imager 810 constructed in accordance with another embodiment. Imager 810 includes a pixel array 812 with active imaging pixels 120, reference pixels 120_{REF}′ located in a first row of array 812 and reference pixels 120_{REF}″ located in a second row of array 812. Row decoder 192 and row control/driver 194 are implemented in the space located vertically above the two rows having reference pixels 120_{REF}′ and 120_{REF}″.

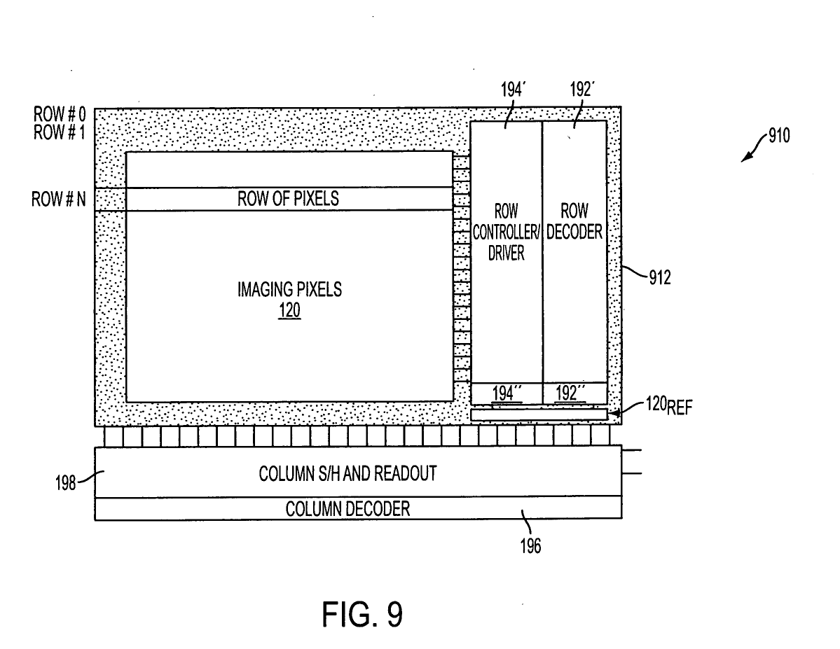

FIG. 9 shows of a portion of a CMOS imager 910 constructed in accordance with another embodiment of the invention. Imager 910 includes a pixel array 912 with active imaging pixels 120 and reference pixels 120_{REF}. Imager 910 includes circuitry allowing reference pixels 120_{REF} to receive control signals different than control signals concurrently received by active pixels 120. Reference pixels 120_{REF} receive control signals from reference row controller/driver 194″ associated with reference row decoder 192″. Active pixels 120 receive control signals from row controller/driver 194′ associated with row decoder 192′. Additional sets of controller/drivers and row decoders could be added. For example, a third row controller/driver 194′″ (not shown) and a third row decoder 192′″ (not shown) could be added to drive a second group of reference pixels. Moreover, column S/H and readout circuitry 198 and column decoder 196 could also be separated in a similar manner to drive different pixels with different control signals.

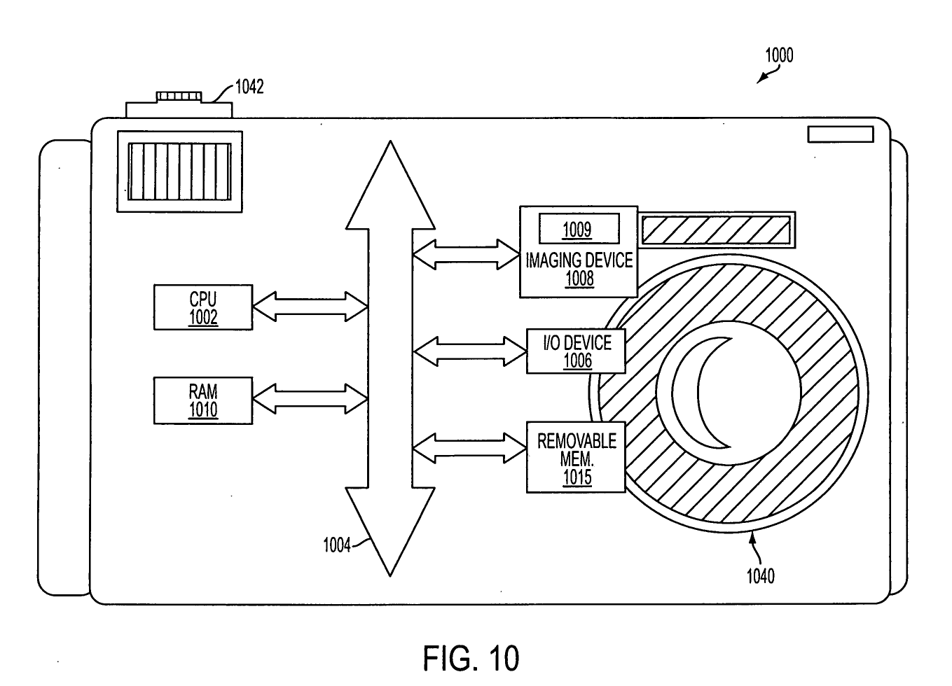

FIG. 10 shows a processor system which includes an imager device 1008 with a pixel array 1009 constructed in accordance with an embodiment of the invention (for example, imager device 110 of FIG. 4). The processor system 1000 is an example of a system having digital circuits that could include imager devices. Without being limiting, such a system could include a computer system, camera system, scanner, machine vision, vehicle navigation, video phone, surveillance system, auto focus system, star tracker system, motion detection system, image stabilization system, and data compression system.

System 1000, for example a camera system having a lens for focusing an image on the pixel array of imager device 1008, generally comprises a central processing unit (CPU) 1002, such as a microprocessor for controlling camera operations, that communicates with one or more input/output (I/O) devices 1006 over a bus 1004. Imager device 1008 also communicates with the CPU 1002 over the bus 1004. Imager device 1008 receives an image through lens 1040 when, e.g., shutter release button 1042 is depressed. The processor system 1000 also includes random access memory (RAM) 1010, and can include removable memory 1015, such as flash memory, which also communicate with the CPU 1002 over the bus 1004. The imager device 1008 may be combined with a processor, such as a CPU, digital signal processor, or microprocessor, with or without memory storage on a single integrated circuit or on a different chip than the processor.

The processes and devices described above illustrate embodiments of the invention. However, it is not intended that the invention be strictly limited to the above-described and illustrated embodiments.

What is claimed as new and desired to be protected by Letters Patent of the United States is:

1. An imager device comprising:
a pixel array comprising:
a first section comprising active pixels; and
a second section comprising optically black reference pixels, the second section located horizontally adjacent the first section; and
a circuit for driving rows of the array, the circuit located at least partially above or below the second section in the columnar direction.

2. The imager device of claim 1, further comprising:
a circuit for:
determining an adjustment value from the optically black reference pixels; and
adjusting pixel values read from the active pixels based on the adjustment value.

3. The imager device of claim 2, wherein:
the adjustment value is an average value obtained from the optically black reference pixels.

4. The imager device of claim 1, wherein:
the circuit is part of an imager processor.

5. The imager device of claim 1, wherein:
the circuit for driving rows is provided to the side of the first section comprising active pixels.

6. An imager device comprising:
a pixel array;
a readout circuit for reading pixel values from active pixels in a first row of the array and pixel values from optically black reference pixels in one or more other rows of the array; and
an adjustment circuit for adjusting pixel values read from the active pixels based on pixel values read from the optically black reference pixels.

7. The imager device of claim 6, wherein:
the readout circuit is operable to concurrently read pixel values from active pixels in a first row of the array and pixel values from optically black reference pixels in one or more other rows of the array.

8. The imager device of claim 6, wherein:
the adjustment circuit is operable to:
average pixel values read from the optically black reference pixels; and
adjust the pixel values read from the active pixels based on the average.

9. The imager device of claim 6, further comprising:
row driving circuitry for the array located at least partially above or below at least one of the optically black reference pixels in the columnar direction.

10. An imager device comprising:
a pixel array comprising active pixels and optically black reference pixels, each comprising a photo sensor, a charge storage region, and a charge transfer transistor for transferring charge from the photo sensor to the storage region; and
a circuit for:
reading out active pixels in one row of the array and optically black reference pixels in another row of the array; and
driving the transfer transistors of the active pixels in the one row with a first control signal which turns on the transfer transistors and for driving the transfer transistors of the optically black reference pixels with a second control signal which turns off the transfer transistors.

11. The imager device of claim 10, further comprising:
an adjustment circuit for adjusting the pixel values read from the active pixels in the one row based on the pixel values read from the optically black reference pixels in the another row.

12. The imager device of claim 11, wherein:
the adjustment circuit is operable to:
average the pixel values read from the optically black reference pixels in the another row; and
adjust the pixel values read from the active pixels in the one row based on the average.

13. A camera comprising:
a lens;
a pixel array for capturing an image through the lens, the array comprising:
a plurality of pixels arranged in rows and columns;
a first set of rows and columns defining active pixels; and
a second set of rows and columns defining reference pixels; and
a circuit for driving rows of the array, the circuit located at least partially above or below at least one of the reference pixels in the columnar direction.

14. The camera of claim 13, further comprising:
a circuit for:
determining an adjustment value from the reference pixels; and
adjusting pixel values read from the active pixels based on the adjusted value.

15. The camera of claim 14, wherein:
the adjustment value is an average value obtained from the optically black reference pixels.

16. The camera of claim 14, wherein:
the adjustment value is determined from reference pixels in one row; and
the pixel values adjusted are read from active pixels in another row.

17. A camera comprising:
a lens;
a pixel array for sensing an image through the lens, the array comprising active pixels and optically black reference pixels, each comprising a photo sensor, a charge storage region, and a charge transfer transistor for transferring charge from the photo sensor to the storage region; and
a circuit for:
reading out active pixels in one row of the array and optically black reference pixels in another row of the array;
driving the transfer transistors of the active pixels in the one row with a first control signal which turns on the transfer transistors and for driving the transfer transistors of the optically black reference pixels with a second control signal which turns off the transfer transistors;
determining an adjustment value from the reference pixels; and
adjusting pixel values read from the active pixels based on the adjusted value.

18. A camera comprising:
a lens;
a pixel array for sensing an image through the lens;
a readout circuit for reading pixel values from active pixels in a first row of the array and pixel values from optically black reference pixels in another row of the array; and
a pixel processing circuit for adjusting pixel values read from the active pixels in the first row based on pixel values read from the optically black reference pixels in the another row.

19. A processor system comprising:
a processor;
an imager device coupled to the processor, the imager device comprising:
a pixel array comprising:
a first section comprising active pixels; and
a second section comprising optically black reference pixels, the second section located horizontally adjacent the first section; and
a circuit for driving rows of the array, the circuit located at least partially above or below the second section in the columnar direction.

20. The processor system of claim 19, wherein:
the imager device further comprises a circuit for:
determining an average value obtained from the optically black reference pixels; and
adjusting pixel values read from the active pixels based on the adjustment value.

21. A processor system comprising:
a processor; and
an imager device coupled to the processor, the imager device comprising:
a pixel array;
a readout circuit for reading pixel values from active pixels in a first row of the array and pixel values from optically black reference pixels in one or more other rows of the array; and
an adjustment circuit for adjusting pixel values read from the active pixels based on pixel values read from the optically black reference pixels.

22. The processor system of claim 21, wherein:
the image device further comprises row driving circuitry for the array located at least partially above or below at least one of the optically black reference pixels in the columnar direction.

23. A processor system comprising:
a processor; and
an imager device comprising:
a pixel array comprising active pixels and optically black reference pixels, each comprising a photo sensor, a charge storage region, and a charge transfer transistor for transferring charge from the photo sensor to the storage region; and
a circuit for:
reading out active pixels in one row of the array and optically black reference pixels in another row of the array; and
driving the transfer transistors of the active pixels in the one row with a first control signal which turns on the transfer transistors and for driving the transfer transistors of the optically black reference pixels with a second control signal which turns off the transfer transistors.

24. The processor system of claim 23, wherein:
the imager device further comprises an adjustment circuit for adjusting the pixel values read from the active pixels in the one row based on the pixel values read from the optically black reference pixels in the another row.

25. A method of operating an imager device comprising:
reading pixel values from active pixels in one row of a pixel array and reference pixels in another row of the array;
forming an adjustment value based on the pixel values read from the reference pixels; and
adjusting the pixel values read from the active pixels in the one row based on the adjustment value.

26. The method of claim 25, wherein:
the reference pixels are optically black pixels.

27. The method of claim 25, wherein:
the adjustment value is an average of the pixel values read from the reference pixels.

28. A method of operating an imager device comprising:
reading out active pixels in one row of a pixel array and optically black reference pixels in another row of the array, the active pixels and optically black reference pixels each comprising a photo sensor, a charge storage region, and a charge transfer transistor for transferring charge from the photo sensor to the storage region;
driving the transfer transistors of the active pixels in the one row with a first control signal which turns on the transfer transistors; and
driving the transfer transistors of the optically black reference pixels with a second control signal which turns off the transfer transistors.

29. The method of claim 28, further comprising:
adjusting the pixel values read from the active pixels in the one row based on the pixel values read from the optically black reference pixels in the another row.

30. The method of claim 28, further comprising:
averaging the pixel values read from the optically black reference pixels in the another row; and
adjusting the pixel values read from the active pixels in the one row based on the average.

31. An imager device comprising:
first circuitry for driving active pixels of a pixel array with a first control signal; and
second circuitry for driving optically black reference pixels with a different control signal, the second circuitry located at least partially above or below the optically black reference pixels in the columnar direction.

32. An imager device comprising:
a pixel array comprising active pixels and optically black reference pixels, each comprising a first component; and
a circuit for causing a first component of an active pixel to receive a first control signal while a first component of an optically black reference pixel receives a different control signal.
